(19) United States
(12) Patent Application Publication
(10) Pub. No.: US 2024/0114982 A1
(43) Pub. Date: Apr. 11, 2024

(54) DIAMOND BOW TIE QUALIFICATION SYSTEM

(71) Applicant: Garry Ian Holloway, Canterbury (AU)

(72) Inventor: Garry Ian Holloway, Canterbury (AU)

(21) Appl. No.: 18/046,935

(22) Filed: Oct. 16, 2022

Related U.S. Application Data
(60) Provisional application No. 63/378,505, filed on Oct. 5, 2022.

(51) Int. Cl. A41D 25/06; A41D 27/00; A44C 17/00

(52) U.S. Cl. CPC A41D 25/06; A41D 27/00; A44C 17/001

(57) ABSTRACT

A diamond bow tie grading system including a structured lighting environment, and an ability to view a diamond at different tilt angles, using the views to find a transition angle where a dark area on the diamond brightens and assigning a bow tie rating using the transition angle. The diamond bow tie grading system may have an observation enclosure with an interior, a gemstone-seat for holding a diamond, located inside the interior of the observation enclosure, a viewport located on the observation enclosure that provides a view of the gemstone-seat, and a tilt angle readout that provides a tilt angle. The interior around the viewport is a dark circle representing an angle of obscuration. The diamond bow tie grading system may include a gemstone-seat manipulator that changes the tilt angle. The viewport may have two viewport openings to provide binocular vision to an observer.

### CROSS-REFERENCE TO RELATED APPLICATION

This application claims the benefit of U.S. Provisional Application No. 63/378,505, filed Oct. 5, 2022.

### BACKGROUND OF THE INVENTION

### Field of the Invention

The present invention relates to the field of gemstone evaluation and more particularly to the field of the grading the bow tie in elongated cut diamond, cuts like Marquise, Oval and Pear shapes.

### Background of the Invention

In a diamond, bow ties are persistent dark areas in the central regions shorter axis of elongated shaped cuts particularly marquise, oval and pear-shaped diamonds that result from an observer or a camera returning little or no illumination in that area. The smaller and less persistent the bow tie dark areas appear through a range of viewing angles, the better, resulting in more desirable diamonds with higher prices. Skilled diamond experts can identify bow ties but grading their severity with a high level of repeatability has not been achieved.

Describing methods to comparatively and consistently provide a quality grade for bow tie dark areas that occur in diamonds would help bring predictability to the elongated diamond marketplace, so market participants could apply consistent predictable discounts to diamonds with bad bow ties.

In a diamond, bow ties are persistent dark areas in the central regions of elongated shaped cuts particularly marquise, oval and pear-shaped diamonds.

Many people believe, and the Gemological Institute of America (GIA) taught for many years, that light leakage causes bow ties, that is, light entering the diamond from above but not returning caused the dark bow ties shaped areas. The light entering the top was thought to not return but rather escaping via the pavilion or lower facets, this turns out to be wrong.

What is needed is a way to comparatively and consistently provide a quality grade for bow tie dark areas that occur in diamonds because that would help bring predictability to the elongated diamond marketplace, so market participants could adjust cutting proportions and apply consistent predictable discounts to diamonds with bad bow ties.

What is needed is a proper understanding of the cause of bow tie dark areas and the development of a diamond bow tie grading system that provides a consistent and objective measure to quantify the bow tie of cut gemstones.

### SUMMARY OF THE INVENTION

A diamond bow tie grading system with an observation enclosure with an interior, a gemstone-seat for holding a diamond, located inside the interior of the observation enclosure, a viewport located on the observation enclosure that provides a view of the gemstone-seat, and a tilt angle readout that provides a tilt angle, where the tilt angle is 0 when the gemstone-seat and the viewport are aligned. The diamond bow tie grading system where on the interior around the viewport is a dark circle representing an angle of obscuration. The diamond bow tie grading system may include a gemstone-seat manipulator that changes the tilt angle. The viewport may have two viewport openings to provide binocular vision to an observer. The observation enclosure may be dome shaped with a torso cut-out. The tilt angle readout may show a north-south tilt angle and an east-west tilt angle.

A diamond bow tie grading system including a structured lighting environment, and an ability to view of a diamond in the structured lighting environment at different tilt angles, and the diamond bow tie grading system may use the views to find a transition angle where a dark area on the diamond brightens and assign a bow tie rating using the transition angle. Where the structured lighting environment is a physical observation enclosure, a virtual environment in a computer program, a ray-tracing computer program providing the views on a display screen, or an automated computer program that finds the transition angle. The views may be generated using ray-tracing and a diamond model, and the diamond model may come from a standard triangle language file.

A diamond bow tie grading process that obtains images of a diamond from a lighting environment with a known angle of obscuration, where each image has an image tilt angle. Record a transition angle where a persistent dark area brightens, where the persistent dark area is near 0 tilt angle, where 0 tilt angle is straight above the table of the diamond. Assign a bow tie rating using the transition angle. The diamond bow tie grading process may determine if the diamond lacks the persistent dark area, and if the diamond lacks the persistent dark area assign a best bow tie rating. The diamond bow tie grading process where determining if the diamond lacks the persistent dark area is determined by the presence of scintillation near 0 degrees tilt angle. The diamond bow tie grading process where the images are in pairs providing binocular views of the diamond, and where determining if the diamond lacks the persistent dark area is determined by the presence of binocular rivalry. The images may be from a diamond tilting video. The images may be generated using ray-tracing and a diamond model and the diamond model may come from a standard triangle language file.

### BRIEF DESCRIPTION OF THE DRAWINGS

FIG. 1 illustrates the gemstone parameters of a cut diamond.

FIG. 2 illustrates parallel light paths for a Type 1 and Type 2 bow tie dark areas.

FIG. 3 illustrates some brilliant oval cut patterns.

FIG. 4 illustrates the influence of pavilion cut angle on the appearance of bow tie dark areas in modern brilliant cut diamonds.

FIG. 5 illustrates the influence of pavilion cut angle on the appearance of bow tie dark areas in traditional oval brilliant cut diamonds.

FIG. 6 illustrates various rotation and tilt directions on a user interface of a ray-tracing computer program for reference.

FIG. 7A illustrates how Type 1 bow tie dark areas change as the diamond tilts and fades at some transition angle.

FIG. 7B illustrates how Type 2 bow tie dark areas change as the diamond tilts and fades at some transition angle.

FIG. 8 illustrates how the eyes can see a facet of the diamond both dark and bright at the same, creating binocular rivalry.

FIG. 9A illustrates a scan of a diamond, with missing facets and bad orientation.

FIG. 9B illustrates the scan of the diamond, with missing facets and corrected orientation.

FIG. 10 illustrates a side view of a dome observation enclosure with a bow-tie-grader sitting and using the dome observation enclosure.

FIG. 11 illustrates a front view of the dome observation enclosure.

FIG. 12 illustrates a rear view of the dome observation enclosure.

FIG. 13 illustrates a top view of the dome observation enclosure.

FIG. 14 illustrates a bottom view of the dome observation enclosure.

FIG. 15 illustrates a flow chart for a bow-tie grading process.

### DETAILED DESCRIPTION

This application describes the causes and provides grading methods of bow ties in elongated cut diamonds.

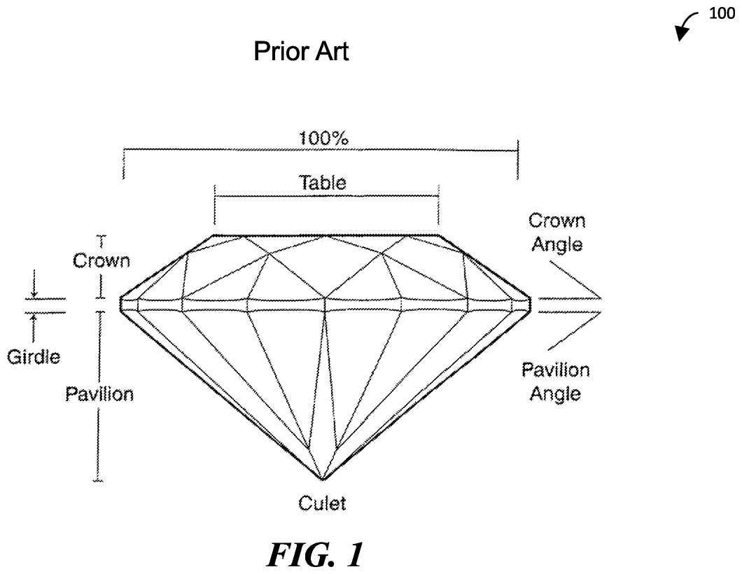

FIG. 1 illustrates the various parameters that define the cut of a diamond, including table, crown angle, pavilion angle, culet and girdle.

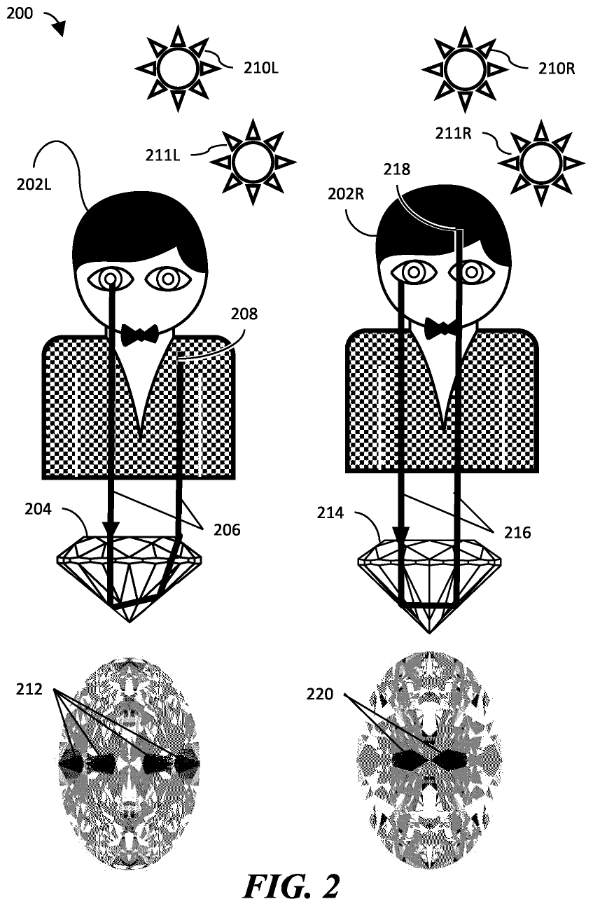

FIG. 2 provides an illustration 200 that depicts the two types of diamond light paths that cause bow tie dark areas. Diamond images produced by ray-tracing programs (for example those produced by DiamCalc™) show that bow tie dark areas have light rays to-and-from that areas that are close to parallel. This indicate that an observer's head will obstruct available light, and thus result in a visual dark area.

The illustration 200 shows Type 1 bow tie dark areas for a left observer 202L viewing a left diamond 204. The cut of the left diamond 204 causes light going through the diamond table to trace a path out the crown so the inbound and outbound paths are parallel light paths 206. The light sources 210L and 211L provide lighting for the left observer 202L, where light source 211L is above (for example, on the ceiling) and behind the left observer 202L. The parallel light paths 206 goes to the eye of the left observer 202L and light from the dark areas 212 appear dark since very little light is on that path because it is only the light reflected from the head or torso of the observer 202L. Illustration 200 shows, for an example, the light path running into the torso of the observer 202 where there is little light reflected from the dark torso 208 and the torso blocks the bright light source 210L. For the Type 1 bow tie left diamond 204 the parallel tracing of the light through the table and crown causes the appearance of the bow tie dark areas 212.

The illustration 200 shows Type 2 bow tie dark areas for a right observer 202R viewing a right diamond 214. The cut of the right diamond 214 causes light going through the diamond table to trace a path out the table so the inbound and outbound paths are parallel light paths 216. The light sources 210R and 211R provide lighting for the right observer 202R, where light source 211R is above (for example, on the ceiling) and behind the head of the right observer 202R. The light entering the eye of the right observer 202R appear dark since very little light is on that path because it is only the light reflected from the head or torso of the right observer 202R. Illustration 200 shows, for an example, the light path running into the hair of the right observer 202R. Thus, there is little light on the parallel light path 216, where there is little light reflected from the hair 218 and the observer's head blocks the bright light source 210R. For the Type 2 bow tie right diamond 214 the parallel tracing of the light in through the table and back out the table of the light causes the appearance of the bow tie dark areas 220.

Thus, for an observer of an elongated diamond the source of darkness for the bow tie dark areas are the head and torso of the observer (or a camera) that blocks direct light and only provides weak reflected light. Bow tie dark areas appear worse for people with big coiffured dark hair and people who examine a diamond from very close proximity, for example short-sighted people. The closer one views a diamond, the more one sees the bow tie dark areas because the head and torso of the observer obstructs the available illumination from the room appearing in the bow tie dark areas of the diamond. By contrast if an observer were to poke a small hole about the size of a pen in a sheet of white copy paper and peek at a diamond, all the dark areas, including any bow tie, will turn white as snow. Alternatively, shining a bright light on the face of an observer while looking at a diamond with bow tie areas will cause the bow tie areas to take on the hue of the skin of the viewer.

One challenge for grading the bow tie dark areas is that for a fair-skinned farsighted blonde observer the bow tie dark areas will look different than what a short-sighted dark-hair dark-skinned observer sees. Human grading of bow tie dark areas requires a controlled lighting environment (i.e. a structured lighting environment) to achieve the desired repeatable results.

A simple tool that provides a controlled lighting environment removing the variations that result from different types of lighting and the size and skin color of an observer, is a pink scope. A pink scope has a structured lighting environment with a dark central lens surrounded by a hot fluorescent pink plastic reflector, such as the Ideal Scope® scope. Illumination from below reflects off the dark lens at the top and the pink walls thus providing a consistent structured lighting environment. The lens of the structured lighting environment creates bow tie dark areas in the same way the head of an observer does or a camera does. The pink reflector may have a dimension and a lens that creates an angular obscuration (angle of obscuration) of around 25°.

The angle of obscuration represents the area of light blocked directly above the face of the diamond. For a human observer, the head is typically blocking the ambient light from reaching the diamond to reflect to the eyes of the observer. For any perpendicular cross-section through the diamond there is 180° above the face of the diamond, going from the horizon's left side to the azimuth at the top to the horizon's right side. The observer will typically view the diamond directly above the face, from the azimuth. When an observer (for example, a person or a camera) views the diamond the observer will occupy some of the 180°. The area the observer occupies will block or obscure some portion of the 180° and how much the observer obscures can be approximated with the angle of obscuration. If the observer is a person, then the cross-section could include the torso of the person, which would provide a much larger angle of obscuration, but most of the light comes from the ceiling or the sky so the cross-section that includes both eyes and most of the light sources fails to include the torso. Thus, a good approximation for the angle of obscuration is what is obscured by the head of the observer. For an average viewer observing at an average viewing distance of an arm's length, the angle of obscuration for the head is about 25°.

The two paths for light passing through a diamond that causes bow tie dark areas are Type 1 “table-crown parallel rays” and Type 2 “table-table parallel rays.” The Type 1 and Type 2 bow tie dark areas are the result of the cut proportions of the diamond.

Type 1 “table-crown parallel rays” bow tie diamonds have pavilions that are too shallow, or the crown is very shallow with some table size influence. For Type 1 caused bow tie dark areas the darkness is the results of the light entering on a crown facet and exiting the table facet, or vice-a-versa with the light entering the table facet and exiting though a crown facet, that is after reflecting off each side of the pavilion. For a table-crown bow tie the ray trace for the bow tie dark area has the light ray entering and leaving at almost the same angle so the entering ray and exiting ray are parallel or almost parallel to each other.

Type 2 “table-table parallel rays” bow tie diamonds have pavilions that are too deep. The crown angle has no influence. For Type 2 bow tie dark areas the larger the table the larger the bow tie. Type 2 bow tie dark areas are the result of the light entering on the table and leaving on the table with the light ray trace having the entry angle and exit angle being parallel or nearly parallel. The light enters through the crown and after reflecting off each side pavilion exits back through the crown. These dark areas also occur in very deep round diamonds where the pavilion angles are close to 45° and are called ‘nail head’ diamonds by diamond experts.

Given these two causes of bow tie dark areas, the pavilion cut angles are the most critical proportions, with crown angles and table size also contributing positively or negatively to the size and appearance of the bow tie dark areas.

Type 1 bow tie diamonds have pavilion angles that are too shallow, or the crown is very shallow. Type 2 bow tie diamonds have pavilion angles that are too deep. Diamonds cut in-between the too shallow or too deep proportions are not necessarily the best cuts, but it is possible to have a wide range of proportions with no bow tie, excellent light performance and appearance. Some experts claim that the best performing oval, marquise and pear shapes all show bow ties, but no substantial evidence supports this claim.

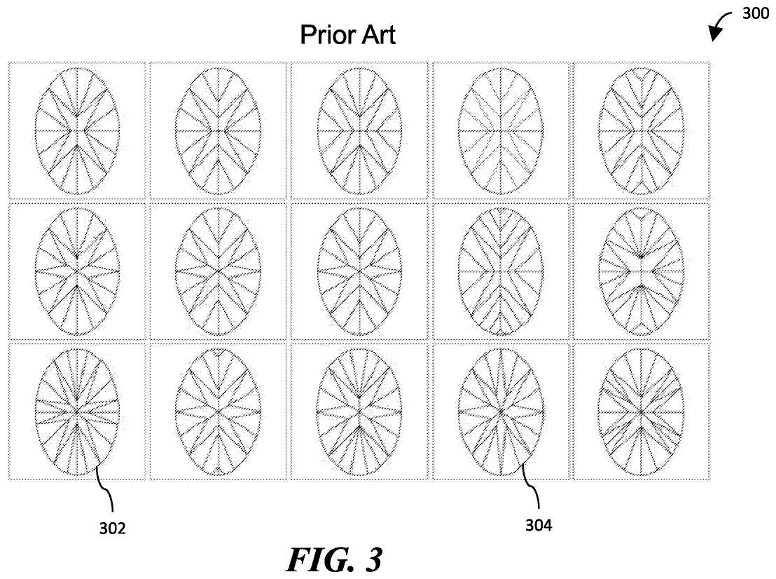

FIG. 3 shows a table of fifteen various facet pavilion patterns. The eight-facet oval brilliant 302 and the traditional oval brilliant 304 are some of the most common pavilion facet patterns for the three cut shapes (oval, marquise and pear). There is little visual difference in terms of the bow tie effect between all the fifteen faceting types. The images presented in this document are for oval cut diamonds, because it is the most popular and is representative of other shapes because marquise and pear shapes follow the same rules as ovals for bow tie dark areas.

Both common facet patterns can show Type 1 and Type 2 bow ties. Type 1 bow ties tend to fade once the diamond tilts far enough, and Type 1 bow ties tend to fade earlier than type 2 bow ties. Type 2 bow ties tend to be persistent through a wide range of viewing angles.

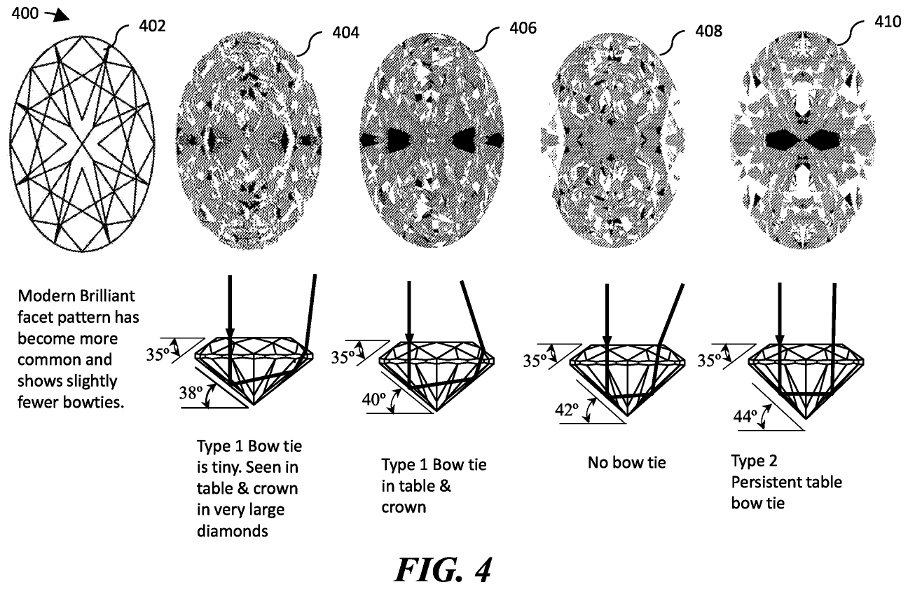

FIG. 4 provides illustration 400 that shows the influence of pavilion cut angle on the appearance of bow tie dark areas on modern brilliant cut diamonds. The modern brilliant facet pattern has become more common over time and shows slightly fewer bow ties. Illustration 400 shows if bow tie dark areas appear for modified brilliant cut diamonds with a 35° crown angle and four different pavilion angles, specifically 38°, 40°, 42° and 44°. Ray-tracing computer program produced the images using a virtual controlled lighting environment with a dark circle around a virtual camera. The dark circle represents the low-reflective (i.e. dark) head, torso or head and torso of an average observer at an average viewing distance. A line drawing 402 shows the cut pattern of the modified brilliant cut. There are four diamond images presented with a view from directly above the crown of the diamond.

The dark circle may be any color that contrasts with the interior color of the observation enclosure, for example the dark circle, may be black, dark gray, red, or florescent pink, any color may be used, just so long as there is a contrast between the interior color and the color of the dark circle. The dark circle may be in the shape of a circle, or other shapes like a octagon, hexagon, pentagon, a square, an oval or any shape that can provide an approximate representation of an angle of occlusion.

A thirty-eight-degree diamond image 404 shows the image produced when the modern brilliant cut diamond has a pavilion angle of 38°. The thirty-eight-degree diamond image 404 shows a tiny Type 1 bow tie that may only be noticeable in the table and crown of very large diamonds.

A forty-degree diamond image 406 shows the image produce when the modern brilliant cut diamond has a pavilion angle of 40°. The forty-degree diamond image 406 displays a bad Type 1 bow tie.

A forty-two-degree diamond image 408 shows the image produce when the modern brilliant cut diamond has a pavilion angle of 42°. The forty-two-degree diamond image 408 displays no bow tie.

A forty-four-degree diamond image 410 shows the image produced when the modern brilliant cut diamond has a pavilion angle of 44°. The forty-four-degree diamond image 410 displays a persistent Type 2 bow tie.

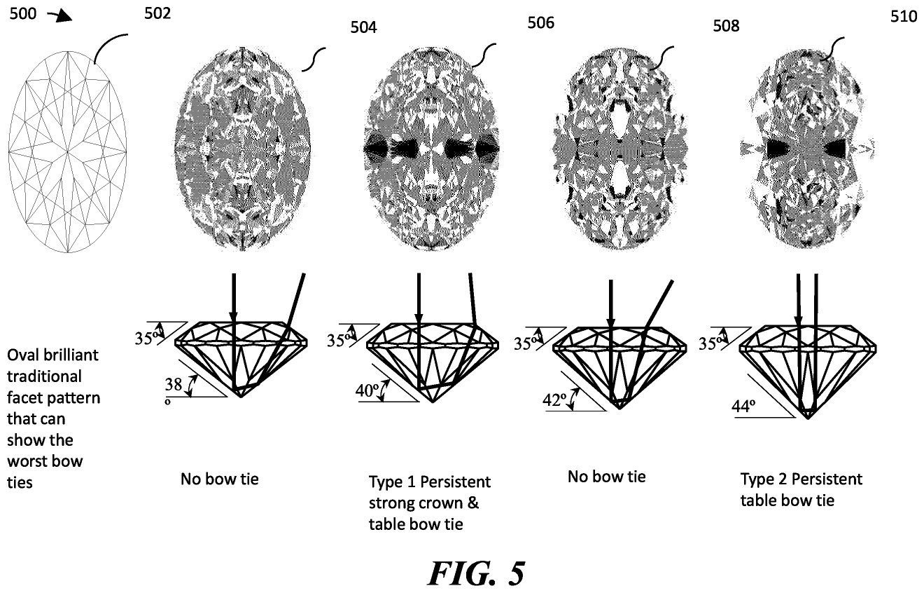

FIG. 5 provides illustration 500 that shows the influence of pavilion cut angle on the appearance of bow tie dark areas in traditional oval brilliant cut diamonds. The traditional oval brilliant facet pattern can show the worst bow ties. Illustration 500 shows if bow tie dark areas appear for traditional oval brilliant cut diamonds with a 35° crown angle and four different pavilion angles, specifically 38°, 40°, 42°, and 44°. Ray-tracing computer program produced the images using a virtual controlled lighting environment with a dark circle around a virtual camera. The dark circle represents the low reflective (i.e. dark) head and torso of the observer. A line drawing 502 shows the cut pattern of the traditional brilliant cut. There are four diamond images presented with a view from directly above the crown of the diamond.

A thirty-eight-degree diamond image 504 shows the image produce when the traditional brilliant cut diamond has a pavilion angle of 38°. The thirty-eight-degree diamond image 504 shows no bow tie.

A forty-degree diamond image 506 shows the image produced when the traditional brilliant cut diamond has a pavilion angle of 40°. The forty-degree diamond image 506 displays a persistent strong Type 1 bow tie.

A forty-two-degree diamond image 508 shows the image produce when the traditional brilliant cut diamond has a pavilion angle 42°. The forty-two-degree diamond image 508 displays no bow tie.

A forty-four-degree diamond image 510 shows the image produced when the traditional brilliant cut diamond has a pavilion angle of 44°. The forty-four-degree diamond image 510 display a Type 2 bow tie.

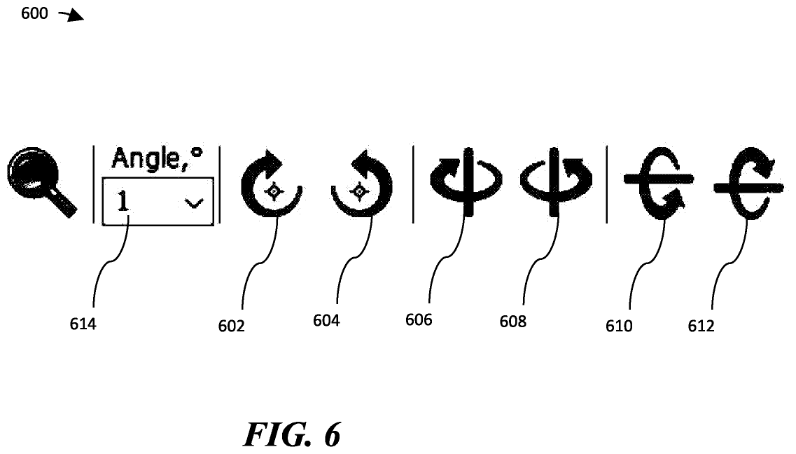

FIG. 6 illustrates a rotating-and-tilting user interface screen 600 for a ray-tracing computer program to reorientate the diamond model. The user interface screen 600 shows a clockwise rotation icon 602, a counter clockwise rotation icon 604, a west tilt icon 606 (also known as left tilt), an east tilt icon 608 (also known as right tilt), a south tilt icon 610 (also known as down tilt), and a north tilt icon 612 (also known as up tilt).

An angle step 614 controls the amount of rotation, for example in degrees, for each tilt or rotation icon button hit. For example, if the angle step 614 is set to 1 degree, then for each hit of the east tilt icon 608 the diamond will tilt to the East by 1 degree.

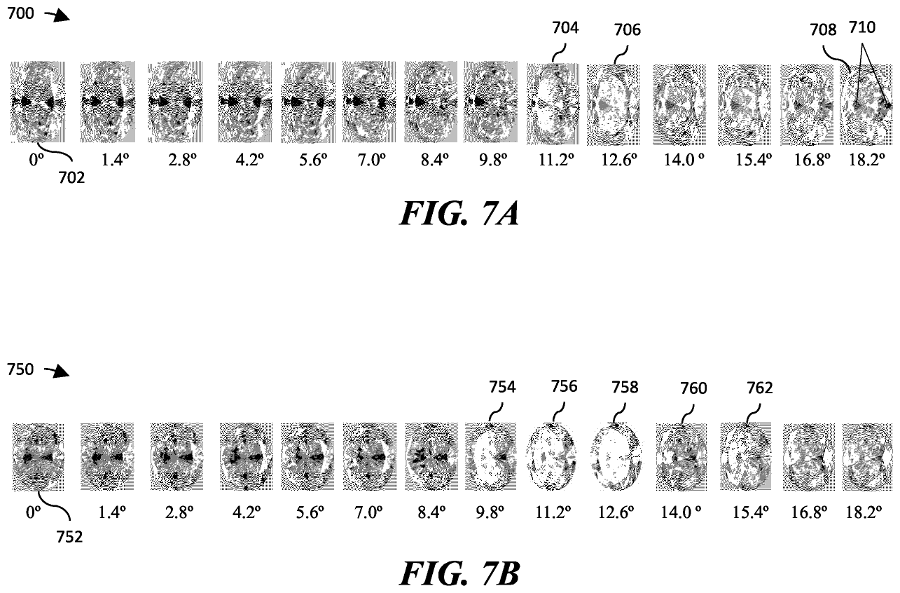

FIG. 7A illustrates a Type 1 series of images 700 that show how the dark areas change on a Type 1 bow tie diamond as the diamond tilts East.

The Type 1 series of images 700 show east tilting of a Type 1 bow tie diamond to about 20 degrees (18.2°), which is about 40 degrees total east-west tilt (a little less than 20 degrees each side of face up).

The Type 1 series of images 700 came from a video of a diamond tilting east. The diamond starts in a face up image 702 on the left side, and the diamond tilts east 1.4° in each image to the right. The bow tie dark areas appear pale gray for some of the images (for example, Type 1 tilt 11.2° image 704 and Type 1 12.6° tilt image 706) because of a glare on the diamond surface from the lighting. The furthest Type 1 tilt 18.2° image 708 still show some visible dark areas 710, so the bow tie dark areas are present through the entire observed east tilt.

Not shown is the tilting of the diamond in the north-south direction. When the diamond was tilted in the north-south direction the bow tie dark areas disappeared after 14° of north-south tilting (7° each side of face up).

The Type 1 bow tie diamond had a large table of 68% and a shallow total depth of 57%. The crown and pavilion angles are very shallow at 29° and 39.5° respectively.

FIG. 7B illustrates a Type 2 series of images 750 that show how dark areas on a Type 2 bow tie diamond change as the diamond tilts East and the bow tie dark areas fade at some transition angle.

The Type 2 series of images 750 show east tilting of a Type 2 bow tie diamond to about 20 degrees (18.2°), which is about 40 degrees total east-west tilt (a little less than 20 degrees each side of face up).

The Type 2 bow tie diamond tilts from face up to about 20 degrees (tilting 1.4 degree more east per image). The Type 2 face up image 752 is on the far left. The bow tie dark areas appear pale grey for some of the images (for example, Type 2 tilt 9.8° image 754, Type 2 tilt 11.2° image 756, and Type 2 tilt 12.6° image 758) because of a glare on the diamond surface from the lighting. The Type 2 bow tie dark areas disappear between Type 2 tilt 14° image 760 and Type 2 tilt 15.4° image 762, so the transition angle is at about 15°.

Not shown are north-south tilting images of the diamond, but the bow tie dark areas disappeared after 14 degrees of north-south tilting (seven degrees each side of face up).

The Type 2 diamond has a large table of 66% and a deep total depth of 65%. The crown was 35° and pavilion angle is a very deep 44°.

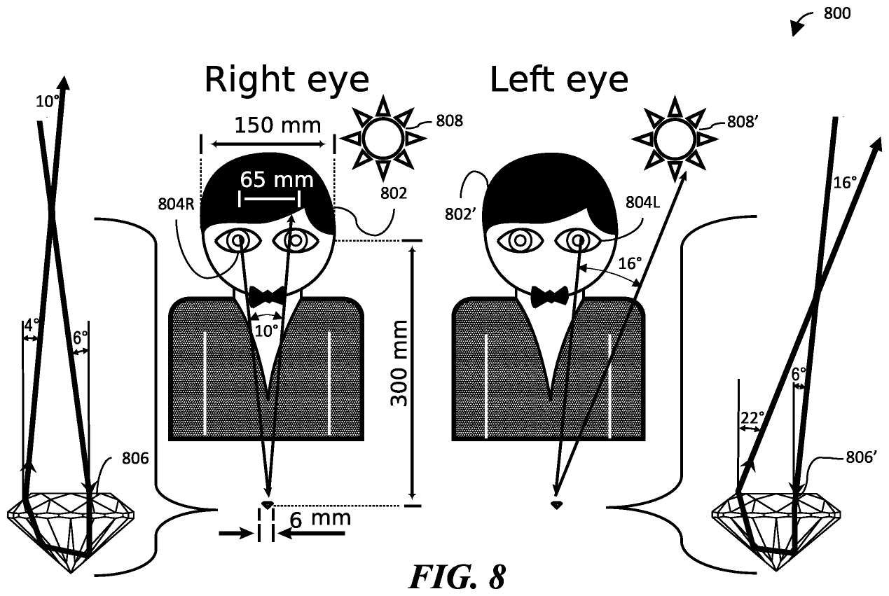

FIG. 8 has illustration 800 showing the ray traces for both the left and right eye of an observer. The illustration 800 shows the right eye ray trace with a right observer portrait 802 and the left eye ray trace with a left observer portrait 802′.

The observations described above in this document were for a single view point, i.e. monocular vision, and are a convenient oversimplification because most humans have two eyes and thus use binocular vision. Viewing a diamond with two eyes (i.e. binocular vision), introduces an angle of less than 10 degrees from the eye to the close edge of the face. This sub 10 degree angle leads to situations where one eye catches light from beyond the close edge of the face while the second eye catches a dark reflection from the face, and this leads to binocular rivalry.

Binocular rivalry occurs when one eye sees a dark source (like a bow tie) and the other eye sees a bright light source at the same area on a diamond. Binocular rivalry enhances the appearance of brilliance, because the two visual paths to a human brain cause a conflict and the way the brain combines the dark and the bright is to create an impression of exceptional brilliance.

Illustration 800 shows how the observer sees a diamond facet 806 as dark in one eye and bright in the other eye, thus creating binocular rivalry. The right eye 804R viewing the diamond will see the light on the path coming from diamond facet 806 that hit the diamond table and reflected off pavilion walls and came from the angled crown, provide a net angle of 10° to the left. Thus, the right eye 804R will see the light reflecting off the left side of the face, where the left face is blocking light source 808, and only has the light reflecting off the left face, thus diamond facet 806 will appear dark to the right eye 804R.

The left eye 804L viewing the diamond facet 806 will see the light on the path coming from the diamond table and reflected off the pavilion walls and coming from the angled crown providing a net angle of 16° to the left. Thus, the left eye 804L will see the light provided by the light source 808′, thus diamond facet 806′ will appear bright to the left eye 804L.

Thus, it may be that a bow tie may be less apparent when viewed with both eyes, because a bow tie that is apparent in a monocular view may be absent in a binocular view.

The bow tie rating system may consider the binocular nature of human vision. For example, if a bow tie dark area is only apparent to one eye, and the other eye sees light at the bow tie dark area, then the rating system may qualify that diamond as not showing a bow tie dark area.

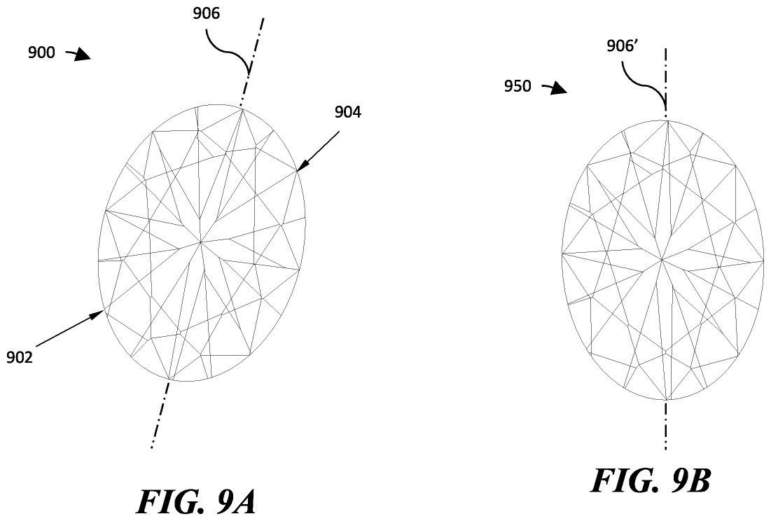

FIG. 9A illustrates a poor diamond scan 900, with missing facets and a bad orientation. The poor diamond scan 900 may be the result of a 3D scan as may appear in a computer package, for example DaimCalc™. Specifically, two lower girdle facet edges are missing. One missing facet edge 902 is missing at about 7 o'clock and a second missing facet edge 904 is missing at about 2 o'clock.

A poor diamond scan 900 can result in an inaccurate grading assessment. A poor scan may be the result of dust on the diamond and cleaning and rescanning may resolve the issue. A poor scan may be resolved by putting the diamond in a better scanner. If a better scan cannot be obtained then the poor scan may be used, in which case, the diamond bow tie grading may have some small inaccuracies.

To be able to tilt the diamond it needs the long north-south axis 906 aligned with vertical.

FIG. 9B illustrates an aligned poor diamond scan image 950 showing the original poor diamond scan 900 rotated so the diamond long axis 906′ is aligned with vertical. This alignment may be achieved in any number of ways, for example, the rotating-and-tilting user interface screen 600 may be used with the angle step 614 set to 1 degree, and diamond may be rotate by pressing the clockwise rotation icon 602 until the diamond long axis 906′ is vertical.

With the diamond scan in the proper vertical orientation, ray-tracing computer program may be used to tilt the diamond and observe the effect on the bow tie dark areas. For example, if there is a bow tie visible in the start position the rotating-and-tilting user interface screen 600 may be used to tilt the diamond in one direction to find the transition angle when the bow tie dark area brightens.

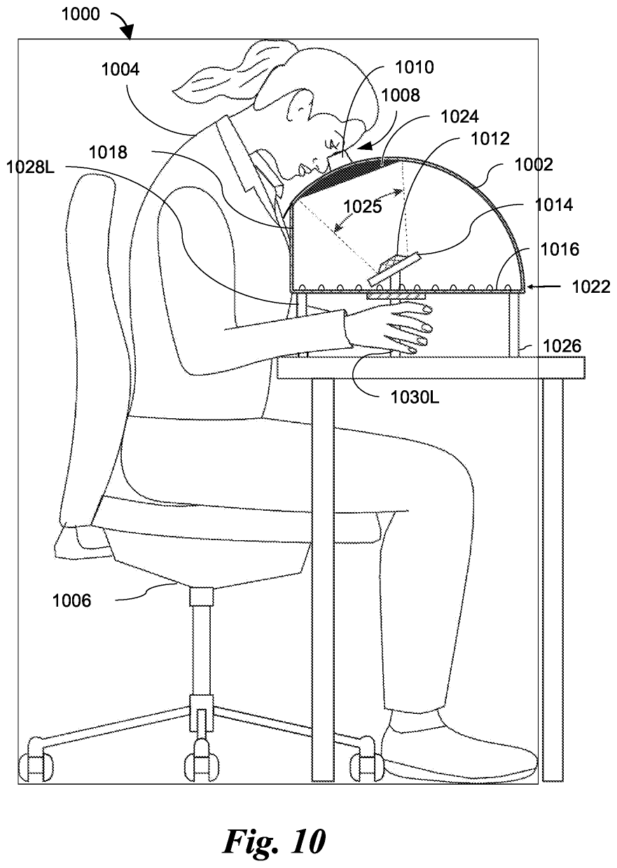

FIG. 10 shows illustration 1000 with a cut away side view of a dome observation enclosure 1002 used by a bow-tie-grader 1004 sitting at a chair 1006 looking through an viewport 1008 with lenses 1010 at the diamond 1012 that is sitting on a gemstone-seat 1014 in the middle of the dome observation enclosure 1002.

A diamond bow tie grading method may use an observation enclosure, for example a physical observation enclosure like the dome observation enclosure 1002. The observation enclosure may provide a consistent viewing environment. The consistent viewing environment may have two aspects, lighting and a consistent angle of obscuration. The lighting environment may be consistent for example having white walls and a dark circle 1024 at the azimuth of the diamond. The dark circle 1024 representing an angle of obscuration 1025, for example a 25° angle of obscuration.

The dome observation enclosure 1002 is generally shaped like a dome with a dome floor 1016 that is flat and a torso cut-out 1018 to receive the torso of the bow-tie-grader 1004. Extending up from the center of the dome floor 1016 is the gemstone-seat 1014 to hold a diamond. There may be a ring of Light Emitting Diodes (LEDs) 1022 at the bottom of the dome observation enclosure 1002. On the dome near the azimuth above the face of the diamond 1012 may be the location of the viewport 1008.

The diameter of the hemisphere of the dome observation enclosure 1002 may range from a few centimeters to over 80 centimeters. The small, few centimeters (cm), dome would make the observation enclosure portable. The larger diameter of 80 cm or more would create a desktop model, like the dome observation enclosure 1002, where the focusing lenses 1010 would provide the close-up view needed to make a standardized viewing distance possible. The observation enclosure may be constructed in a variety of shapes, for example a geodesic dome, a cylinder, a box, a pyramid or other shapes that provide a structured lighting environment.

Lighting may illuminate the interior of the dome observational enclosure 1002 from below providing indirect lighting, for example the lighting may be the ring of LEDs 1022. The hemisphere dome 1002 may have a light-colored or bright-colored internal walls (for example white, florescent pink, or other light or bright colors) with a dark circle 1024 surrounding the viewport 1008, where the dark circle 1024 provides lighting representing an angle of obscuration.

The torso cut-out 1018 may allow the bow-tie-grader 1004 to comfortably access the viewport 1008 to view the diamond 1012.

The torso cut-out 1018 may enable the bow-tie-grader 1004 reach in and easily access to the gemstone-seat 1014.

The torso cut-out 1018 may be totally open toward the diamond or there may be a screen between the cutout and the diamond, for example a screen hanging from the edge of the torso cut-out 1018.

If the torso cut-out 1018 is open the bow-tie-grader 1004 may need to wear consistent colored clothing. The bow-tie-grader may wear consistent clothes that will reflect the light as a human observer would, for example a neutral grey or some other predetermined lab dust coat to provide the realistic and consistent lighting environment that can represent a human observing the bow tie areas in a diamond by virtue of their torso obstructing direct light sources, and instead only providing reflected lights.

If the torso cut-out 1018 has a screen it may be made of cloth or material with small holes in it to see the gemstone-seat 1014. The screen may provide a picture of a clothed torso for a consistent realistic lighting environment, for example, an image of a grey dust lab coat or a suit coat. The screen may have cuts in it to allow the bow-tie-grader to reach in and swap the diamond 1012 on the gemstone-seat 1014.

The gemstone-seat 1014 may have a variety of inserts to suit different diamond sizes and shapes. The gemstone-seat 1014 may allow an elongated diamond be placed in a slot or hole on a gimbal, to allow the diamond to be tilted. The motion of the swivel may be restricted to only tilt north-south or east-west. For example, fixing east-west tilt to zero and only allowing tilting in the north-south direction or keep north-south tilt and only tilt east-west. The bow-tie-grader 1004 may be able to tilt the gemstone-seat 1014, for example by use of their hand or hands.

The gemstone-seat 1014 may start tilted at around ten or fifteen degrees toward the bow-tie-grader as an appropriate gemstone-seat may allow a diamond to tilt to about thirty degrees without sliding off. The gemstone-seat 1014 may have a small suction system to hold the diamond in place during tilting.

The observation enclosure may have an ergonomic alignment feature. For example, the ergonomic alignment feature may be the swivel gemstone-seat starts tilted towards the bow-tie-grader, so the bow-tie-grader head may be in a comfortable neutral position.

The observation enclosure may have an ergonomic alignment feature similar to a microscope with prisms to redirect the line-of-sight of the bow-tie-grader so their head may remain in a neutral position, to avoid stooped over and looking down on the face of a diamond 1012 that is facing straight up. With the tilted binocular view the crown can point straight up, avoiding the need for a suction device to hold the diamond in place, and the bow-tie-grader can look forward with their head in a neutral position with the prism or mirror providing a direct view from above the face of the diamond crown.

The bow-tie-grader 1004 may place the diamond 1012 on the gemstone-seat 1014, for example by reaching through the torso cut out 1018. The bow-tie-grader 1004 may change the size of the slot or hole on the gemstone-seat 1014 to accommodate different size diamonds.

As the bow-tie-grader 1004 manipulates the tilt of the gemstone-seat 1014 the dome observation enclosure 1002 may report the tilt angles. For example, the dome observation enclosure 1002 may provide a tilt angle readout. The tilt angle readout may display the tilt angle or tilt angles, for example tilt angle east-west and tilt angle north-south. The tilt angle readout may use mechanical mechanisms to display the tilt angles. The tilt angle readout may use electronics. The tilt angle readout may measure and record the tilt angles. For example, a button or computer mouse button that when activated, records the tilt angles. The recorded tilt angles may be the transition angles.

The viewport 1008 may be located directly above the face of the diamond 1012. When the face of the diamond points directly at the viewport 1008 the tilt angles may read 0°, that is both the north-south tilt angle and the east-west tilt angle may report 0°. The tilting angles may be created by the movement of the gemstone-seat, or the viewport may move relative to the stationary diamond to create the tilt angles. The tilting may be constrained to only tilt east-west or north-south, for example the viewport can only move from both angles report 0° to go east-west or north-south.

The viewport 1008 may have a single viewport opening for a single eye to look through or there may be two viewport openings, one for each eye to look through. A viewport opening may be with or without lenses (i.e., just holes). The viewport 1008 may use lenses as is suitable for a given viewing distance. The lens may provide low magnification (for example 2 times) or high magnification (for example, up to 10 times). The high magnification would be appropriate for a space saving smaller dome where the observer eye is too close to the diamond to focus without the aid of higher magnification. The bow-tie-grader 1004 may look through the viewport 1008 directly at the face of the diamond 1012 that is tilted towards the viewport 1008, where the diamond 1012 is mounted on the gemstone-seat 1014.

The observation enclosure 1002 might also include highlight lighting to enable the observation enclosure be used as an aid to sales.

The observation enclosure may have a camera mounted to enable the making of photos and videos of the diamond.

The ring of LEDs 1022 may be arranged so that they are not shining directly into the eyes of the bow-tie-grader 1004 viewing the diamond 1012.

The dome observation enclosure 1002 may have legs, for example, a front leg 1026, a rear left leg 1028L, and a middle left leg 1030L. The legs may be height adjustable for operator comfort.

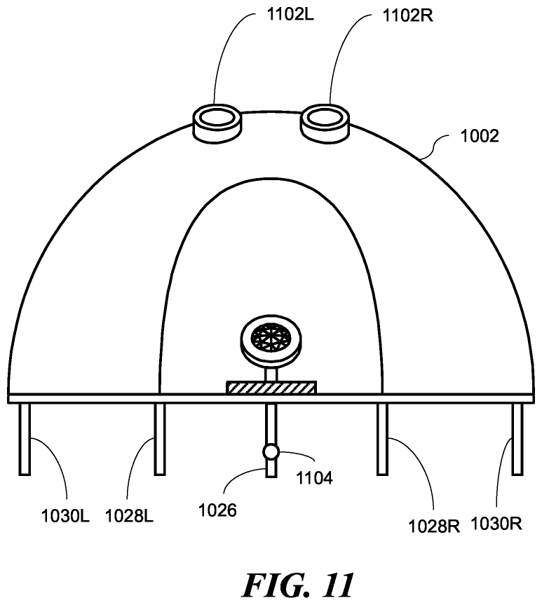

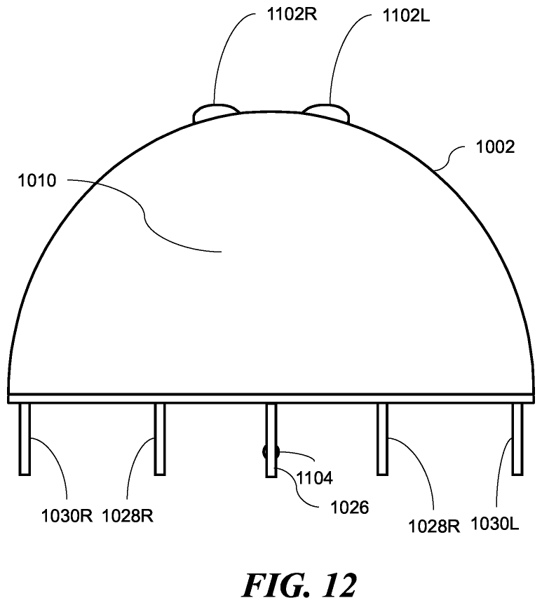

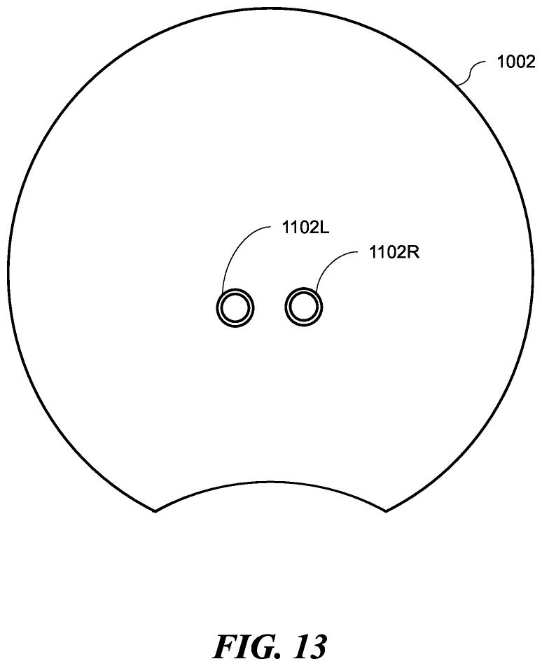

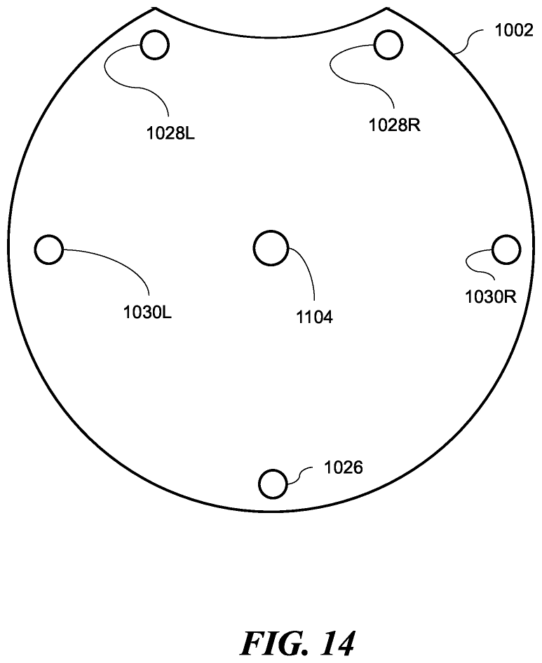

FIG. 11 illustrates a front view, FIG. 12 illustrates a rear view, FIG. 13 illustrates a top view, and FIG. 14 illustrates a bottom view of the dome observation enclosure 1002 with a left viewport opening 1102L and a right viewport opening 1102R. The dome observation enclosure 1002 is shown with a front leg 1026, a rear left leg 1028L, a rear right leg 1028R, a middle left leg 1030L, and a middle right leg 1030R. The dome observation enclosure is shown with a gemstone-seat manipulator 1104, that may be moved and twisted to introduce tilt angle between the viewport 1008 and the diamond 1012.

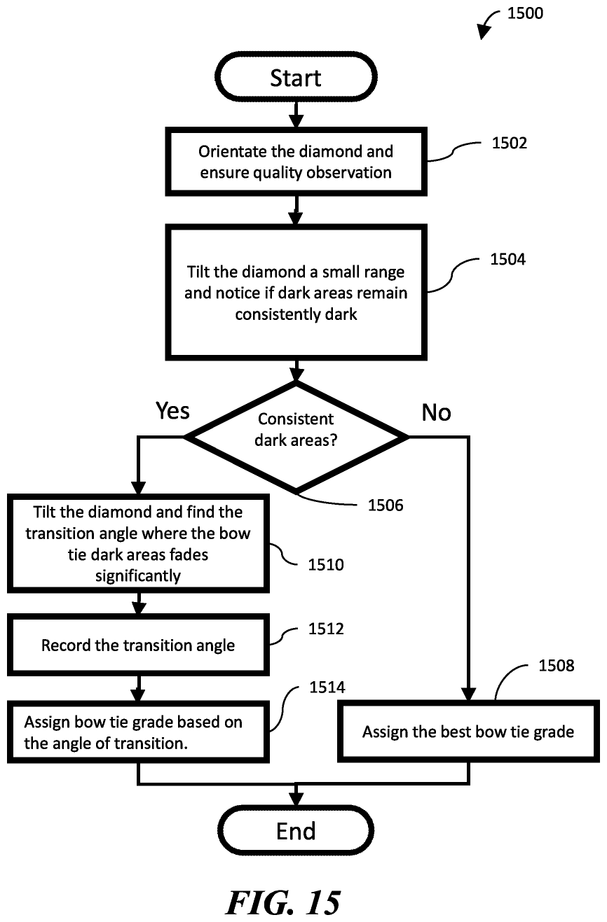

FIG. 15 illustrates a flow chart 1500 for a bow-tie grading process. Other flow charts or processes besides the one presented here could be used to implement a bow-tie grading process, this is just one example.

The diamond bow tie grading may be conducted using various technologies, for example: using a physical observation enclosure, using a diamond tilting video (a video of a diamond tilting), manually using a virtual environment (for example, a bow-tie-grader using a diamond model file with existing ray-trace computer program), or using an automated virtual environment (for example using a diamond model file with an automated computer program). These various technologies can provide images of a diamond at different tilt angles.

When grading on a physical observation enclosure a structure lighting environment should be provided with the ability to adjust the tilt angle, for example as the dome observation enclosure 1002 provides.

When grading using a diamond tilting video, it is traditional for diamond video system to use a macro lens and the lens may have an angle of obscuration of more than 30°. For example, a camera with a 50 mm lens at a distance of 80 mm from the diamond provides an angle of obscuration of around 36°, which will show far larger dark areas than would be visible to a human observer with normal binocular eye sight. It would be preferred to adjust the video system to provide an angle of obscuration more in line with an average observation by a human. One approach would be to place a small white 50 mm circle of white paper with a circular hole of 35 mm over the lens of the camera thereby reducing the angle of obstruction to around 25 degrees. There could be other ways to adjust the bow-tie grading to take into account the difference in angle of obscuration if adjustment is needed in the diamond bow tie grading, for example because of the large angle of obscuration, an adjustment may be special look-up tables for diamond tilt video evaluation based on an 36° angle of obscuration.

When grading manually using a virtual environment a virtual lighting environment may be created in a computer ray-tracing model. One example of a manual process using a virtual environment is to use a virtual structured lighting environment modeled in ray-tracing computer program to produce images on a display screen, like a computer screen, television, projector, printout or anything that can show an image to a bow-tie-grader.

The diamond bow tie grading may be conducted using a 3-Dimensional model (3D model) of the diamond being assessed. For example, a 3D model from a digital scan of a diamond. The 3D model may be from a Standard Triangle Language format STL File. The STL file may be produced by non-contact diamond scanner, for example the commercial instruments from Sarine™ or Helium™.

For example, a commercial ray-tracing computer program for diamonds (like DiamCalc™) may be used to produce images from a scan of a diamond, i.e. a diamond model, for example a STL File. Diamond grading laboratories make use of non-contact diamond scanners to measure and report diamond data, for example the various dimensions and parameters of a diamond. The non-contact diamond scanner builds a three-dimensional (3D) model as part of the process of calculating the diamond data and that model may be saved as an STL file. This STL file of a diamond to be graded by importing into the ray-tracing computer program. The diamond model may come from other sources as described in U.S. Pat. No. 10,739,271 issued Aug. 11, 2020, which is incorporated by reference for all purposes as if fully written in this document.

When grading using an automated virtual environment the structured lighting environment may be represented in a computer program by ray-tracing technology and a diamond model provided by a STL file that has been loaded into the computer program. The automated virtual environment may be hosted on a server (for example an internet server or cloud server) and the STL file may be uploaded through the internet so the diamond bow tie grading process may be accessible as a service on a website.

The process flow 1500 starts at box 1502 where the process may adjust the orientation of the diamond and assure the observation will be of high quality. FIG. 9 shows an inaccurate 3D scan with missing facets at 902 and 904.

When conducting the bow-tie grading on a physical observation enclosure, for example the dome observation enclosure 1002, the long axis of the oval of the diamond should be aligned to vertical, and the diamond should be without any dust or obstructions that would interfere with viewing the diamond.

When conducting the bow-tie grading on a diamond tilting video, the diamond tilting video for bow tie assessment may be produced with a known angle of obscuration. The video format needs to appropriately capture the tilting of the diamond, for example a video format used among professional diamond buyers has the diamond held top-to-bottom along the longest axis of the oval by two contact points for example pins. The pins may rotate thus providing east-west tilt, that may be captured in a video which may be used for a bow-tie grading assessment. Similarly, the diamond may be mounted with the diamond across the oval's short axis to be able to capture a video for north-south tilt assessment.

When conducting the bow-tie grading manually using a virtual environment, for example using an existing commercially available diamond ray-tracing computer program with a diamond model scan (for example, a diamond scan STL file), the diamond scan should be of sufficient quality and the diamond model should be properly orientated.

The manual grading process using a virtual environment should check that the scan is accurate. Sometimes a small diamond scanned with a lens or a device intended for much larger diamonds will not have the accuracy and resolution needed. For example, a scanner like the Sarine Diamension HD scanner has interchangeable lenses for different sized diamonds. The Sarine Diamension HD scanner can scan diamonds from 3.0 to 28.0 millimeters in diameter (approx. 0.1 to 70.0 polished carats) by using different lenses, specifically lens #0 is appropriate for 13.0-28.0 mm diameter diamonds; lens #1 is appropriate for 6.0-21.0 mm diameter diamonds; lens #2 is appropriate for 4.0-13.0 mm diameter diamonds; and lens #3 is appropriate for 3.0-8.0 mm diameter diamonds.

The manual grading using a virtual environment may re-orientate the diamond model to align the long axis of the oval to vertical. The process may ensure the quality of the observation, for example ensure the scan is good and that all facets have been captured and that was no dust or lint impairing the scan of the diamond.

The manual grading using a virtual environment may establish the lighting environment, like setting the lighting to cosine lighting (or Ideal Scope® lighting). For example, in the DiamCalc™ computer program click on the light bulb on the left toolbar and then select Ideal Scope®.

The manual grading using a virtual environment may adjust the diamond image size to provide consistent grading results. For example, to adjust the diamond image size some commercial computer programs will allow the size to be controlled once clicking on the diamond image window and then pressing ‘control’ & ‘+’ keys for larger, and ‘control’ & ‘-’ keys for smaller.

The manual grading using a virtual environment may consider binocular view by generating a pair of diamond images, one for the right eye and one for the left eye. The pair of images can be viewed on a 3D screen or virtual reality head set in stereo vision. The bow-tie-grader would be able to detect binocular rivalry. With a set of pairs images the bow-tie-grader would have a series of binocular views to be able to give a proper grading to the diamond scan.

When grading using an automated virtual environment the automate computer program may automate the grading by doing all the manual steps including creating a pairs of images for a binocular view to discern if there is any binocular rivalry to influence the bow tie grade. When grading using the automated virtual environment, may grade the bow tie using artificial intelligence to assess the bow tie. For example, using machine learning techniques to train an algorithm to determine the transition angle based on input of images with image tilt angles and assessed transition angles (for example as assigned by human bow tie graders). Or train an algorithm to assign the bow tie grade based on input of images with image tilt angles and output bow tie grades.

At box 1504 the process flow 1500 continues and the diamond is tilted a small range and it is noted if the dark areas remain consistently dark or changes from dark to light to dark (scintillation). The small range may be 5 degrees. The tilting may be in one, two, three or all four directions, for example just east tilt; east tilt and west tilt; east tilt and north tilt; east tilt, west tilt, north tilt and south tilt; or other combinations.

If a bow tie dark area flashes on and off as the diamond tilts through different positions this is seen as a positive feature that can be called scintillation and adds to the sparkle of a diamond. In a nice round diamond, the dark eight rayed star seen through a pink scope, like the Ideal-Scope®, has exactly the same cause and effect as type-one bow tie. The difference in a well-proportioned diamond—as one looks at it and pivots the stone—the dark areas flash to bright with very slight change in viewing angle causing the diamond to sparkle and scintillate. Bow ties on the other hand are persistent through a wide range of tilting. So, if a part of a bow tie flashes dark-light-dark-light when tilting then that tilting range does not count as a persistent bow tie, and this is not the transition angle. If a dark zone flicks on and off in a few degrees, this is a positive attribute and if observed with just a small tilt when viewed above the crown then the diamond may be considered to not have a bow tie dark area at all. This positive scintillation will make the diamond appear more brilliant in real life.

When grading using a physical observation enclosure, the tilting in the small range may be done by the bow-tie-grader adjusting the gemstone-seat manipulator 1104 to determine if there is scintillation.

When grading using a diamond tilting video, the first images showing tilt (for example the first 5° of tilt) may be used to determine if there is scintillation.

When grading manually using a virtual environment the bow-tie-grader may use the ray-tracing computer program to produce images at various tilts of the diamond model.

When grading using an automated virtual environment the automated computer program may be configured to count pixels to assess dark areas (i.e., bow ties) in the central horizontal region of an oval diamond, for example with 30% of the horizontal axis (15% each side of horizontal) and assessing the size (pixels considered dark) as the images are tilt to amount range rotation until the dark areas became lighter or brighter. This may be accomplished by counting dark pixels, either just the total number of dark pixels with the central horizontal region or determining contiguous dark pixels to determining if there is a dark area and then tilting and seeing if that contiguous dark pixel areas remains or decreases significantly. This same process may be used with the two camera-points, corresponding the viewports or the two eyes of the human. In this way if the two camera-points do not both have overlapping dark areas it could indicate binocular rivalry.

When grading using an automated virtual environment system may convert the diamond image to gray scale. The diamond bow tie grading may have a threshold value that if below (for example, if below 40% black) the area may be considered dark. The diamond bow tie grading system may start with the image directly above the crown then that area may be considered a dark area and if there are a contiguous set of pixels above a bow tie area minimum size then that might qualify as a diamond with a bow tie.

At diamond box 1506 if there are consistent dark areas then the process flow 1500 continues at box 1510, else if there were no consistent dark areas then the process flow 1500 continues at box 1508. No consistent dark areas may occur when tilting causes the dark area to scintillate (go light-dark-light-dark) as tilting occurs. Scintillation maybe considered as occurring near 0° degrees tilt angle when with a small amount of tilt an area changes from dark to light to dark, for example within a 5° tilt angle. No consistent dark areas may occur if the diamond is demonstrating binocular rivalry (one eye sees a dark area but the other eye sees the area as light). No consistent dark areas may be based only on scintillation, binocular rivalry or both scintillation and binocular rivalry.

At box 1508 the process flow 1500 will assign the best bow tie grade, because there is no consistent dark areas.

At box 1510 the process flow 1500 continues and the diamond is tilted to find the transition angle where the bow tie dark area brightens.

The diamond is tilted until the dark area brightens, meaning the dark area either disappear or change from dark to light for example the dark areas has disappeared, substantially diminishes, turns lighter, fade significantly, begins to turn grey, or becoming very small (where size maybe relative to the size of the diamond). Identifying when the bow tie brightens may involve some judgement for a human observer. Using a pink scope, like an Ideal-Scope®, when the facets of the dark area starts to turn grey it usually means that facet can begin to show an attractive fire dispersion colored flash.

The angle the dark areas brightens is recorded as the transition angle.

After some data is gathered it may be found that the diamond bow tie grading may be simplified, for example by eliminating the need for both west and east tilting, and just relying on west if that has proven to provide reliable bow tie grades. Tilting south, or toward the observers' body, commonly produces a larger bow tie effect (because it will be reflecting more darkness from the body of the observer), however in real life most people view diamonds in rings slightly tilted away from the body (north). The diamond bow tie grading may be done with only the north tilting away as that is a more common movement of the hand of someone wearing a ring and more diamonds are worn as rings than all other purposes combined. So, a simplified grading process may only use the north tilting. The simplified grading process may be more efficiency.

When grading using a physical observation enclosure, the bow-tie-grader may tilt the diamond using the gemstone-seat manipulator 1104 till any dark areas disappear and that transition angle may be recorded with the click of a mouse. The system may allow the bow-tie-grader to quickly rotate the diamond in an arc of a direction and as the bow tie dark areas begin to fade and disappear then to move more carefully to record the transition angle.

When conducting the bow-tie grading on a diamond tilting video, the diamond tilting video may be produced with a consistent camera providing an angle of obscuration and a known tilt angle for the images that make up the video, for example with a known interval of tilting between the images that make up the video, or a labeling or tagging of the image with the tilt angle, or the tilt angle in the scene. A video bow tie grade may be accomplished by determining the transition by finding the images where the dark bow tie dark areas become brighter and disappear and either using the angle on the transition image or the angle between the two images (one with dark areas and one being lighter).

When grading manually using a virtual environment the diamond model may be tilted until the transition angle is found. This process may be expedient, and for example only take 2 minutes or less.

As an example, in the commercial DiamCalc™, the alignment tool on the bottom left tool bar, may be used to identify how far the diamond can tilt in each direction before the transition angle is passed. For example, in the ray-tracing computer program rotating-and-tilting user interface screen 600, the angle step 614, may be used when determining the of transition angle. The angle step 614 maybe set, and then the tilt button pressed till the transition angle is passed, then a smaller angle step 614 may be used, for example the angle step may be started at various increments for example 5°, 2° or 1°.

When grading using an automated virtual environment, the automated computer program may use ray-tracing technology to automate the process describe for the manual using a virtual environment.

Next at box 1512 the process flow 1500 continues and the transition angle is recorded.

The bow-tie grading process may record a transition angle, some transition angles, or all the transition angles (east transition angle, west transition angle, north transition angle and south transition angle). For example, the process may record just three directions, east transition angle, west transition angle, and north transition angle. This three-transition-angle example may better represent the real-world diamond observer because most often a diamond observer tilts the diamond away from (i.e., north tilt) not toward because a diamond on a ring is easier to tilt away so that the three-transition-angles may provide adequate information to make a bow tie grade assessment.

When grading on a physical observation enclosure once the bow-tie-grader finds the transition angles they may indicate the transition angle, for example with and push or click of a button or mouse that would record the tilt angle as the transition angle. When the transition angle button is pressed the system may note the specific transition angle as the appropriate one (east, west, north or south). The system may record a positive east-west tilt angle as the west transition angle. The system may record a negative transition angle east-west as the east transition angle. The system may record a positive north-south tilt angle as the north transition angle. The system may record a negative transition angle north-south tilt angle as the south transition angle.

When grading using a diamond tilting video, the bow-tie-grader may find the two images where the bow tie dark area transitions, and based on the tilt of diamond in the two images on either side of transition, the bow-tie-grader may assign the transition angle. Based on the series of images in the diamond tilting video the bow-tie-trader may know which transition angle (e.g. north transition angle, south transition angle, east transition angle, or west transition angle) to assign the transition angle to. An image tilt angle (the tilt angle of the diamond in the image from the tilting video) may be associate to the images in a number of ways, either by the tilt angle being captured in the image, or each image being a certain incremental step from the starting 0° position, and a repeatable order of tilting, or a standard set of images making up the video, or determined by the changes in the facet edges from the starting 0° position.

When grading using a diamond tilting video, either a bow-tie-grader may determine the transition angle, or an automated computer program may determine the transition angle.

When grading manually using a virtual environment the bow-tie-grader may count and record the number of degrees for each set of four tilts.

When grading using an automated virtual environment, the automated computer program may use the images produced and the pixel counting described above to determine the transition angles.

Next at box 1514 the process flow 1500 continues and uses the transition angle(s) in determining the bow tie grade.

The transition angles and a predetermined grading standard may be used to provide automated and consistent bow tie grades for an elongated diamond.

Data (like transition angle) can be compared to standard look up tables or predetermined grade values and transition angles the range of persistence of the bow tie dark areas. The look up tables may be physical printed tables or the data may be stored in a computer database. Thus, a diamond can be assigned a bow tie grade by the diamond bow tie grading, for example by a bow-tie-grader using printed tables indexed by transition angles.

The transition angles may be compared to standard look up tables or predetermined grade values and boundaries based on the range of tilt that provides persistence bow tie dark areas. The look up tables may be physical or the data may be stored in a computer database. Thus, a diamond can be assigned a bow tie grade using the transition angle or transition angles.

The bow tie grades may consist of a limited set of grades, for example three, four or five grades. The terms may be the same as the five commonly used for other diamond grading factors: Excellent, Very Good, Good, Fair and Poor or the terminology could be bow tie specific. For example:
No Bow Tie, Slight Bow Tie, and Strong Bow Tie;
None, Very Very Slight, Very Slight, Slight and Strong;
No Bow Tie, Slight Bow Tie, Moderate Bow Tie and Strong Bow Tie; or
None Bow Tie, Faint Bow Tie, Medium Bow Tie and Strong Bow Tie.

Other factors may be taking into account when deterring the bow tie grade, for example, scintillation or relative size of the bow tie dark area.

The size of the bow tie related to the size of a diamond, may be incorporated into the grading process. A diamond under half a carat with a small bow tie might hardly be visible. The same relative size bow tie in 5 ct diamond would be more obvious and therefore potentially more annoying to the observer. The diamond bow tie grading may take into account a relative size factor.

The process flow 1500 ends after the bow tie grade was assigned either in box 1510 or box 1514.

Variations and additions are possible to the system as will be apparent to those skilled in the art.

1. A diamond bow tie grading system comprising:
an observation enclosure with an interior,
a gemstone-seat for holding a diamond, located inside the interior of the observation enclosure,
a viewport located on the observation enclosure that provides a view of the gemstone-seat,
a tilt angle readout that provides a tilt angle, where the tilt angle is 0° when the gemstone-seat and the viewport are aligned.

2. The diamond bow tie grading system of claim 1 where on the interior around the viewport is a dark circle representing an angle of obscuration.

3. The diamond bow tie grading system of claim 1 further comprising a gemstone-seat manipulator that changes the tilt angle.

4. The diamond bow tie grading system of claim 1 where the viewport has two viewport openings to provide binocular vision to an observer.

5. The diamond bow tie grading system of claim 1 where the observation enclosure is dome shaped, with a torso cut-out.

6. The diamond bow tie grading system of claim 1 where the tilt angle readout shows a north-south tilt angle and an east-west tilt angle.

7. A diamond bow tie grading system comprising:
a structured lighting environment,
an ability to views of a diamond in the structured lighting environment at different tilt angles,
using the views to find a transition angle where a consistent dark area on the diamond brightens, and assigning a bow tie rating using the transition angle.

8. The diamond bow tie grading system of claim 7 where the structured lighting environment is a physical observation enclosure.

9. The diamond bow tie grading system of claim 7 where the structured lighting environment is virtual in a computer program.

10. The diamond bow tie grading system of claim 9 where the structured lighting environment is a ray-tracing computer program providing the views on a display screen.

11. The diamond bow tie grading system of claim 9 where an automated computer program finds the transition angle.

12. The diamond bow tie grading system of claim 9 where the views are generated using ray-tracing and a diamond model.

13. The diamond bow tie grading system of claim 12 where the diamond model comes from a standard triangle language file.

14. A diamond bow tie grading process comprising:
obtaining images of a diamond from a lighting environment with a known angle of obscuration, where each image has an image tilt angle,
recording a transition angle where a persistent dark area brightens, where the persistent dark area is near 0° tilt angle, where 0° tilt angle is straight above the table of the diamond, and
assigning a bow tie rating using the transition angle.

15. The diamond bow tie grading process of claim 14 further comprising:
determining if the diamond lacks the persistent dark area, and if the diamond lacks the persistent dark area assign a best bow tie rating.

16. The diamond bow tie grading process of claim 15 where determining if the diamond lacks the persistent dark area is determined by the by the presence of scintillation near 0° tilt angle.

17. The diamond bow tie grading process of claim 15 where the images are in pairs providing binocular views of the diamond, and
where determining if the diamond lacks the persistent dark area is determined by the presence of binocular rivalry.

18. The diamond bow tie grading process of claim 14 where the images are from a diamond tilting video.

19. The diamond bow tie grading process of claim 14 where the images are generated using ray-tracing and a diamond model.

20. The diamond bow tie grading process of claim 19 where the diamond model comes from a standard triangle language file.
